(19) United States
(12) Patent Application Publication
(10) Pub. No.: US 2022/0245723 A1
(43) Pub. Date: Aug. 4, 2022

(54) Social Media-Enabled Market Analysis and Trading

(71) Applicant: Shaun Broderick Culler, Millwood, WA (US)

(72) Inventor: Shaun Broderick Culler, Millwood, WA (US)

(21) Appl. No.: 17/649,540

(22) Filed: Jan. 31, 2022

Related U.S. Application Data
(60) Provisional application No. 63/143,953, filed on Jan. 31, 2021.

(51) Int. Cl. G06Q 40/04; G06Q 30/02; G06Q 50/00

(52) U.S. Cl. CPC G06Q 40/04; G06Q 50/01; G06Q 30/0201

(57) ABSTRACT

This disclosure describes apparatuses and methods of a social media-enabled (SM-enabled) market analysis and trading platform. In some aspects, an SM-enabled market platform receives, from a social media source, information related to a tradable unit (TU) or commodity. The SM-enabled market platform may then analyze the TU related information to generate SM-based trading information (e.g., price estimates or trends) or commands (price adjustments for pending orders). The SM-enabled market platform may then generate a TU trade order based on the SM-based trading information. By so doing, the SM-enabled market platform may leverage the social media information to execute the generated or adjusted TU trade order to their benefit, such as with increased earnings.

### BACKGROUND

Pricing and conditions of many commodities markets are dynamic and can fluctuate over periods of time. Generally, brokers and traders of commodities can analyze mainstream news articles and earning reports of companies to determine when to buy or sell commodities. Information of these mainstream news articles and earning reports, however, is often out-of-date by the time of publication or fails to capture other information that may be useful to the brokers and traders of commodities.

### SUMMARY

Various aspects of social media-enabled market analysis and trading platform are described. In aspects, a social media-enabled market analysis and trading platform (SM-enabled platform) accesses one or more social media platforms to obtain data relating to a tradable unit (TU). In the context of this disclosure, a TU may include any publicly or privately tradable commodity, currency, digital/crypto currency, equity security, option, future, negotiable financial instrument, or the like. The SM-enabled platform may also access a trading platform that provides TU related information and/or enables the SM-enabled platform to execute of trade related activities for TUs. Alternatively or additionally, the SM-enabled platform may obtain data for a TU that is unrelated to social media, which may include historical, delayed, or real-time information (e.g., price, volume, trend, news, announcements, pattern, or the like) relating to the TU.

In aspects, the SM-enabled platform may also connect and/or interact with other instances of SM-enabled platform to exchange or aggregate data relating to one or more TUs, or to coordinate respective activities of the two or more SM-enabled platforms. For example, respective instances of an SM-enabled platform may be associated with a user device or user account, and multiple instances of the SM-enabled platform may communicate via any suitable network (e.g., cloud-based, service-based, or peer-to-peer network). To enable or reflect any of the operations described, a user device (e.g., smart phone or laptop) may present a user interface (UI) to display or present relevant information to a user with which the SM-enabled platform is associated. For example, an application interface (app interface) of the SM-enabled platform may present a search bar through which the SM-enabled platform receives a selective input from a user indicative of a stock name or ticker symbol for analysis or tracking. Based on the selective input from the user, the SM-enabled platform may generate SM-based actionable information or commands, which the user may choose to select to generate a trade order of modify parameters of an existing trade order. These are but a few examples of aspects of social media-enabled market analysis and trading, which are described throughout this disclosure in the context on an example environment, example framework, example methods, and/or example systems and devices.

### BRIEF DESCRIPTION OF THE DRAWINGS

The details of one or more aspects of a social media-enabled (SM-enabled) market analysis and trading platform are described below. The use of the same reference numbers in different instances in the description and the figures indicate similar elements:

FIG. 1 illustrates an example environment in which an SM-enabled market analysis and trading platform may be implemented;

FIG. 2 illustrates an example configuration of various components of an SM-enabled market analysis and trading platform in accordance with one or more aspects;

FIG. 3 illustrates an example method for SM-enabled market analysis and trading;

FIG. 4 illustrates an example method for providing SM-based trading information to a social media platform or another SM-enabled platform;

FIG. 5 illustrates an example method for generating or altering parameters of a TU trade order based on information received from another SM-enabled platform; and

FIG. 6 illustrates example system and devices that may enable various aspects of an SM-enabled market analysis and trading platform in accordance with one or more aspects.

### DETAILED DESCRIPTION

Many commodity trading programs accept only simple types of user commands, which generally enable traders or brokers to buy or sell commodities at predefined prices or volumes as specifically directed by the traders or brokers. For example, a trader may set a sell limit command to place a sell order for a number of stock shares in his or her portfolio when a price of the stock crosses a specified price. While this command may automate the trader's attempt to execute a stock trade at the specified price, the trader typically determines and sets the specified price based on cursory information published by news agencies and the company to which the stock belongs. In some cases, these preceding types of trading programs provide a summary of recent news articles about the company and a summary of the company's latest quarterly report. As such, the trader may be unaware of other information that may affect the price of the stock (e.g., real-time information) and may determine their trade order prices incorrectly due to limited information and/or be unable to react to other pricing trends or action that is typically unreported. This may result in the loss of earnings when these simple orders or commands alter, or fail to alter, portfolio positions of the trader because the traders rely on limited information of these preceding trading programs or are unaware of relevant information until after it has already been factored into the commodity's price.

In contrast to preceding trading systems, this document describes various aspects of social media-enabled market analysis and trading platform. In aspects, a social media-enabled market analysis and trading platform (SM-enabled platform) accesses one or more social media platforms to obtain data relating to a tradable unit (TU). In the context of this disclosure, a TU may include any publicly or privately tradable commodity, currency, digital/crypto currency, equity security, option, future, negotiable financial instrument, or the like. The SM-enabled market platform may also access a trading platform that provides TU related information and/or enables the SM-enabled platform to execute of trade related activities for TUs. Alternatively or additionally, the SM-enabled platform may obtain data for a TU that is unrelated to social media, which may include historical, delayed, or real-time information (e.g., price, volume, trend, news, announcements, pattern, or the like) relating to the TU.

In aspects, the SM-enabled platform may also connect and/or interact with other instances of SM-enabled platform to exchange or aggregate data relating to one or more TUs, or to coordinate respective activities of the two or more SM-enabled platforms. For example, respective instances of an SM-enabled platform may be associated with a user device or user account, and multiple instances of the SM-enabled platform may communicate via any suitable network (e.g., cloud-based, service-based, or peer-to-peer network). To enable or reflect any of the operations described, a user device (e.g., smart phone or laptop) may present a user interface (UI) to display or present relevant information to a user with which the SM-enabled platform is associated. For example, an application interface (app interface) of the SM-enabled platform may present a search bar through which the SM-enabled platform receives a selective input from a user indicative of a stock name or ticker symbol for analysis or tracking. Based on the selective input from the user, the SM-enabled platform may generate SM-based actionable information or commands, which the user may choose to select to generate a trade order or modify parameters of an existing trade order. These are but a few examples of aspects of social media-enabled market analysis and trading, which are described throughout this disclosure in the context on an example environment, example framework, example methods, and/or example systems and devices.

Example Environment

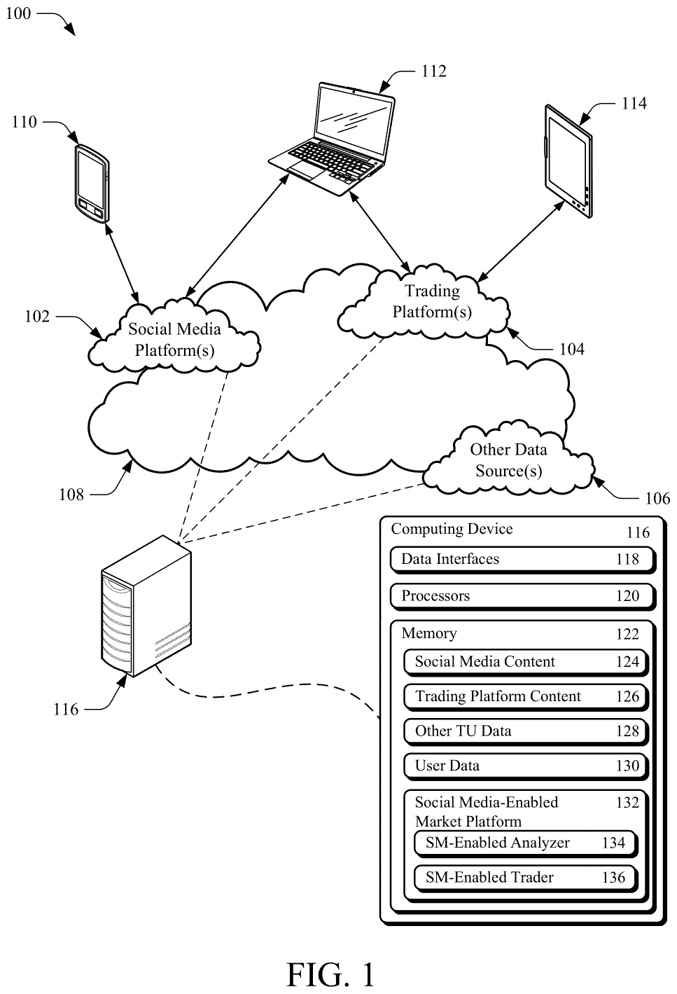

FIG. 1 illustrates an operating environment 100 in a digital environment that includes social media platforms 102, trading platforms (e.g., brokerage services) 104, and other data sources 106, each of which is accessible through the Internet 108 or other networks. The social media platforms 102 may be configured as any suitable type of site, such as a social network, web-log (blog), image posting board, microblog, media (e.g., photo, image, or video) sharing site, collaborative site (e.g. chat channels or threads), wiki site, and the like. The social media platforms 102 store and distribute social media content, which includes social media posts, threads, indications of interactions with social media contents, and so forth. The social media content and interactions therewith may be posted or made by users of various personal devices 110, 112, and 114, respectively. Although individual instances of the social media content are shown for visual brevity, the social media platforms 102 may receive social media posts, updates, topics, impressions, or interactions from any or all of the personal devices 110 through 114. In some aspects, one or more users of the personal devices 110 through 114 are users of the trading platforms 104 and/or other data sources 106.

The trading platform 104 may include a TU trading or TU brokerage platform from which TU related information may be obtained and/or through which the SM-enabled market platform can execute TU orders or alter parameters of TU orders. In some cases, a user provides account information (e.g., user login and password, or other form of authorization) that enables the SM-enabled platform to access the user's account of the trading platform 104. Accordingly, the SM-enabled market platform may have access to one or more social media accounts of a user and one or more commodity trading account of the user.

The other data sources 106 may include other sources of information that the SM-enabled platform can access through the Internet or another network to which the SM-enabled platform or user can access. In some cases, a user provides account information (e.g., user login, password, other form of authorization) that enables the SM-enabled platform to access the user's account associated with the other data source, which may include one of email, a messaging application (e.g., instant messaging or chat applications), news site, use group, banking website, and so forth. Generally, the SM-enabled market platform may obtain TU related information from the other data sources 106 that may be similar to or different from the TU related information obtained from social media platforms or trading platforms. In aspects, the TU related information may include data or information associated with the TU (e.g., a stock, ticker symbol, commodity, etc.), such as published marketing material, released product roadmaps, press releases, announcements, support forums, blogs, webpages, and so on.

The operating environment 100 also includes a computing device 116 having data interfaces 118, which enable communication with the social media platforms 102, trading platforms 104, and other data sources 106 via the Internet 108 or other intermediate networks. In aspects, the computing device 116 may represent a server, a cloud instance, or user device on which an SM-enabled market platform is implemented. In some cases, the data interfaces 118 are wired data interfaces, such as Ethernet or fiber optic network adapters. In other cases, the data interfaces 118 include wireless interfaces, such as modems configured to communicate over a wireless local-area-network (WLAN) or wire-less wide-area-network (WWAN). The computing device 116 also includes processors 120 and a computer-readable storage memory 122 (memory 122). The memory 122 may include any suitable type of memory/storage media or devices, such as volatile memory, non-volatile memory, RAM storage drives (e.g., optical or magnetic), or the like. In the context of this disclosure, the memory 122 stores instructions, code, information, data, or the like of the computing device 116, and thus does not include carrier waves or transitory signals.

In this particular example, the memory 122 includes social media content 124, trading platform content 126, and other TU related data 128, which may be obtained or extracted from respective sources. The memory may also store user data 130, as well as instances of a social media-enabled trading platform 132 (SM-enabled platform 132), an SM-enabled analyzer 134, and an SM-enabled trader 136. In aspects, the social media content 124 may include text-based content, such as microblog posts (e.g., Tweets), social network posts or comments, emojis, graphics, images, universal resource locators (URLs), condensed URLs, tagging prefixes or suffixes (e.g., hashtags), usernames, aliases, email addresses, phone numbers, coordinates, timestamps, and the like. Alternately or additionally, the social media content 124 may include audio, video, images, photos, screen captures, icons, emoticons, or any suitable combination thereof. In some cases, the social media content includes metrics or indications of content interaction, which may include one or more of microblog (e.g., Twitter) likes, retweets, broadcasts, endorsements, comments, hashtags, trends, and so forth. The metrics or indications can include information related to a user specific or a topic specific following, which may include social media (e.g., Facebook) likes, comments, reactions, image posting boards (e.g., 4chan/8kun) thread length, replies, green text, post interactions. Alternatively or additionally, the social media content and/or interactions may include threaded (e.g., reddit subs of specific interest) or channelized content, as well as moderator comments, upvotes/down votes per thread, numbers of comments (either positive and/or negative reactions), or the like.

In aspects, any or all of the social media content, such as those described herein, may be extracted and/or quantified by the SM-enabled platform as social media content, metrics of social media interest, or social media-related sentiment that can be used to generate TU related data. The SM-enabled platform may use this TU related data to, in some implementations, generate TU trade orders (e.g., place buy orders) or to modify parameters of existing TU orders (e.g., alter a number of shares of an order to be transacted or alter a price threshold at which to execute the order). In some aspects, the SM-enabled platform may decode or interpret non-textual indicia to determine social media-related data for a TU or market. For example, the SM-enabled platform may decode and use emojis or emoji strings to gauge interest, sentiment, or support related to or associated with a TU (e.g., stock or commodity), as well as a likely trend associated with pricing or volume of the TU. In some cases, the SM-enabled platform may identify and associate emojis that carry positive connotations and associate the indication of interest with a particular direction in predicted price movement.

In aspects, some of the social media content 124 obtained or extracted from a social media platform relates to or is associated with a TU, which may include a TU selected by a user or a TU that the SM-enabled platform is tracking based on activity or interest in the TU (e.g., as indicated by social media content). In other words, the SM-enabled platform may determine to track a TU based on indications of interest or sentiment related to the TU from social media content accessed or received by the SM-enabled platform.

In aspects, the trading platform content 126 may include respective data for one or more TUs received from a TU trading platform 104, such as include historical, delayed, or real-time information (e.g., price, volume, trend, news, announcements, pattern, or the like) relating to the TU. For example, the SM-enabled platform may obtain data for a TU that is unrelated to social media, such as historical, delayed, or real-time information pricing information and press releases relating to the TU. In some aspects, the other TU data 128 may include information or data associated with the TU (e.g., a stock, ticker symbol, commodity, etc.), such as published marketing material, released product roadmaps, press releases, announcements, support forums, blogs, webpages, and so on. Thus, the other TU data 128 may be obtained from other sources 106 (e.g., help forum, product assistance page, produce update page, etc.) that do not include a social media platform 102 or trading platform 104. The memory 122 also includes user data 130, which may include user login information for social media, trading apps, bank apps, and/or other data sources that enables the SM-enabled platform to access and associated with the respective platforms or apps to obtain from or provide data to one or more of the other platforms. As such, the SM-enabled platform may use the user data 130 to access personal or private social media platforms, trading platforms, or other data sources to obtain one or more of the social media content 124, trading platform content 126, and/or other TU data 130.

In aspects, the computing platform 116 also includes a social media-enabled trading platform 132 (SM-enabled platform 132) with an SM-enabled analyzer 134 and an SM-enabled trader 136, which may be embodied on the memory 122 and executed by one or more of the processors 120 to implement aspects described herein. Generally, the SM-enabled platform 132 may access the social media content 124 and/or the trading platform content 126 to analyze TU related information and generate or modify trade orders for a TU. For example, the SM-enabled platform 132 can interact with SM-enabled analyzer 134 to pre-process, extract, and construct relationships for language or terms of the social media content and TU. The SM-enabled trader 136 can quantify the relationships or dependencies of the terms based on a variety of factors, such as importance, frequency, linguistic characteristics, or manually chosen or selected dependencies. Based on the results of the analysis of the TU related information, the SM-enabled trader 136 can generate or modify trade orders executed through a trading platform 104 associated with the SM-enabled platform 132. How the SM-enabled platform 132, SM-enabled analyzer 134, and SM-enabled trader 136 are implemented and used vary and are described throughout this disclosure.

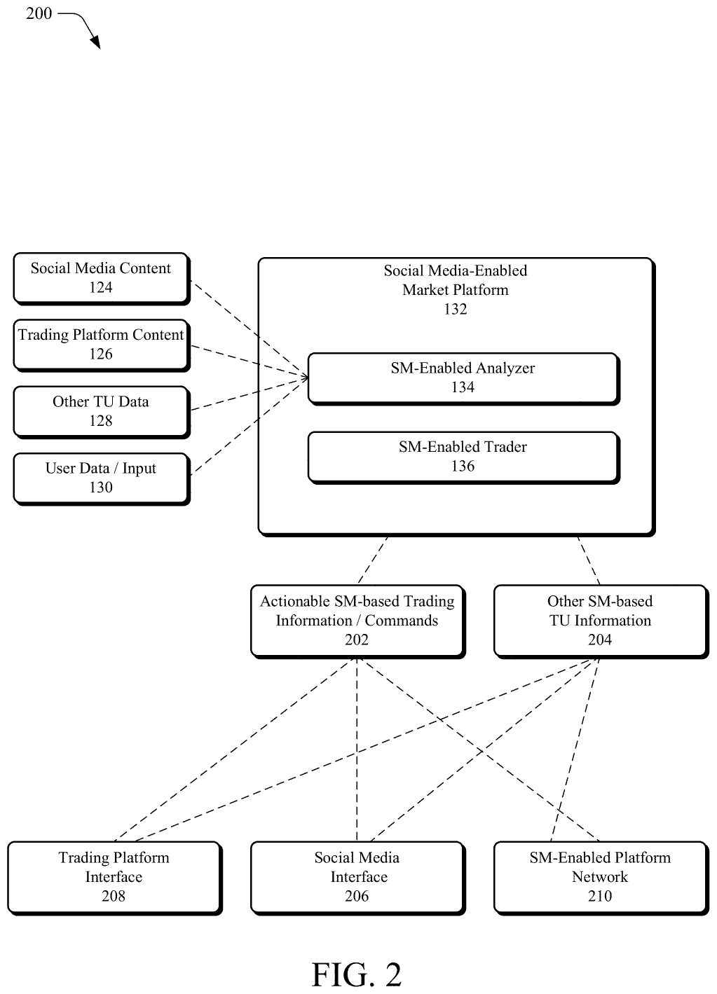

FIG. 2 illustrates at 200 an example configuration of various components of an SM-enabled market analysis and trading platform in accordance with one or more aspects. In the illustrated configuration or framework, various components of FIG. 1 are shown in an example configuration, though the components may be implemented in any suitable organization or combination to implement the aspects described herein. The example configuration of components shown at 200 may be implemented in whole or part by a computing device, such as a server of an SM-enabled platform, cloud-based computing resources, user device, or the like. For example, the framework 200 can be implemented to provide an SM-enabled market platform 132 that is accessible by multiple users or members of the SM-enabled market platform. In other cases, the framework may be implemented to provide one instance of an SM-enabled market platform 132 (e.g., in app form, downloaded from an app store) for a user or member, which may optionally interface with other instances of the SM-enabled market platform 132 associate with other users or an SM-enabled market platform service that networks multiple users. In this example, SM-enabled platform 132 includes the SM-enabled analyzer 134 and SM-enabled trader 136, which can be implemented as functions or extensions of the SM-enabled market platform. As shown in FIG. 2, the SM-enabled platform 132 has access to social media content 124 of social media platforms, trading platform content 126 of trading platforms, other TU data 128 from other sources, and/or user data/input 130, which may be obtained from a data store associated with the user or from user input.

In aspects, the SM-enabled platform obtains, organizes, and identifies information relating to a TU, which may include a stock, commodity, or other negotiable instrument (e.g., futures, options, ETFs, derivatives, crypto currency, and so forth). In some cases, the SM-enabled platform processes social media content, trading platform content, other TU data, and/or user data/input by extracting the data from respective repositories of websites, platforms, accounts, documents, and files. For example, the SM-enabled platform can extract textual data from any suitable social media or platform content, example of which include tables, hyper-terminal markup language (HTML) pages, extensible markup language (XML) pages, spreadsheets, presentations, databases, messages, social media posts, social media impressions or interactions, calendars, email, and the like. The SM-enabled analyzer 134 may also lemmatize the textual data or decoded image data (e.g., emojis) into variant form and/or resolve the textual information for pronoun or subject references. This may enable the SM-enabled platform to do further processing of the identified terms, symbols, and words of the textual or decoded image data.

In aspects, based on the words, terms, and symbols, the SM-enabled analyzer 134 builds structures that represent relationships between the terms of textual data for a specific TU (e.g., stock ticker, commodity name, or futures contracts). In some cases, the SM-enabled analyzer 134 generates these relationships using natural language processing (NLP) to parse pairs or groups of the terms, symbols, or words. In other cases, the SM-enabled analyzer 134 forces dependencies between pairs of terms, symbols, or words based on manual input (e.g., user input or input from another instance of a SM-enabled platform), such as pairs or groups of terms, symbols, or words that are likely to appear relevant to the TU or a TU of interest. The relationships may be represented using any suitable structure, such as a semantic network or semantic graph.

The SM-enabled analyzer weights or quantifies TU and social media content relationships constructed by the SM-enabled platform. The SM-enabled analyzer 134 may weigh patterns of relationships of social media interest that are indicative of the relationships being more like to result in market movement for the TU. In aspects, any one or more of these relationships, structures, weights, quantifications, and so on may comprise actionable social media-based (SM-based) trading information or command In some cases, the SM-enabled analyzer receives the relationships of the TU and social media content as respective semantic graphs. In such cases, the relations can be weighted such that edges between nodes of similar categories are weighted similarly. For example, if an edge a product term (e.g., TU ticker) to a date term (e.g., options expiry date) is observed to be strong in the social media content, the weight is increased in edges between the TU ticker and date term. Alternately or additionally, the edges of semantic graphs can be weighted by performing queries in which terms or categories are randomized. In aspects, the SM-enabled analyzer may provide an output (e.g., actionable SM-based trading information or command) for a specific TU that includes one or more of an alert for the TU symbol, a summary the social media interest or sentiment, a prediction of a price or volume, of the like.

In various aspects, an SM-enabled platform can interface/associate with the trading platform, social media platform, or other instances of an SM-enabled platform via respective interfaces. As shown in FIG. 2, the SM-enabled platform 132 may exchange actionable SM-based trading information (e.g., generate an order to buy/sell or obtain calls/puts at X price based on SM-based analysis) or commands (e.g., price or quantity adjustments for a TU order) with any other platform. Alternatively or additionally, they may exchange other SM-based TU information with any other platform (e.g., generate a social media post indicating interest in a TU or a change in TU trade behavior).

In some implementations, the SM-enabled platform includes an interface to a trading platform, which may enable the SM-enabled platform to access/use—personal account of user to enable trade execution, set/update trades based the output of the SM-enabled platform. In some cases, the SM-enabled platform includes an interface to access market information real-time or delayed, which may be same or different from the trading platform. SM-enabled platform may also access, based on user provided credentials, a social media account of the user, which enables the SM-enabled platform to track trends/obtain data, social media content, track social media interactions, such as upvotes, replies, thread depth, tree/child structures depth, overall popularity of a subject/thread or a child thread split off from a primary topic/subject. In some cases, the SM-enabled platform connects with a mobile application to enable the SM-enabled platform to access microblogging or messaging apps to export or spread TU-related data (e.g., buy symbol “X” or buy calls to hedge puts or vice versa) to other users or instances of the SM-enabled platform. Thus, multiple instances of the SM-enabled platform may operate as a peer network in which respective information is obtained and/or processed by an instance of an SM-enabled platform and shared with the other instances of the SM-enabled platform to enable further analysis (e.g., with different or additional data) or action by those instances of the SM-enabled platform.

Example Methods

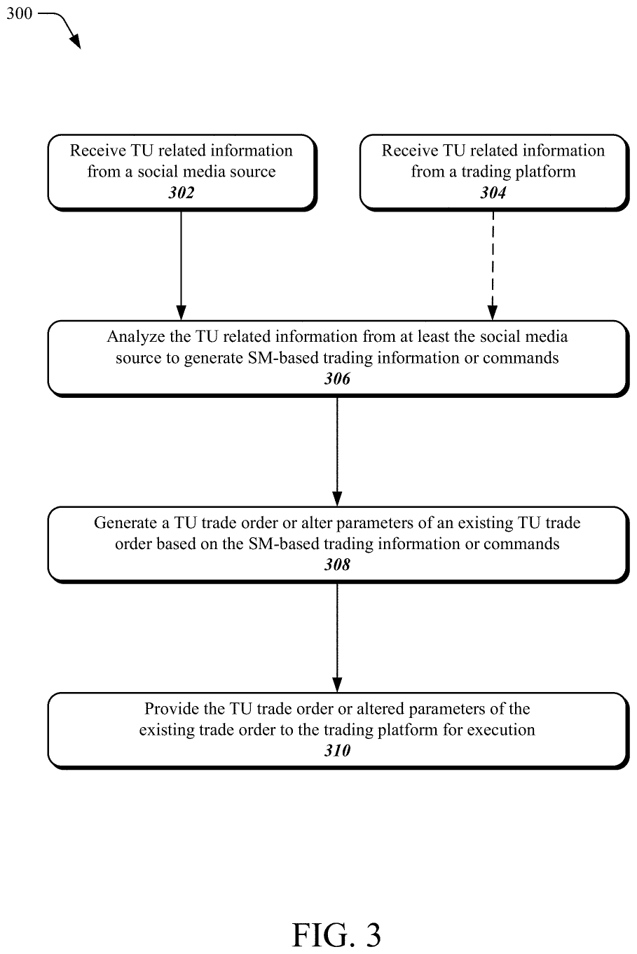

FIGS. 3-6 illustrate example methods 300 through 500 for SM-enabled market analysis and trading in accordance with one or more aspects. These methods may be implemented using any of the environments and entities described herein, such as the SM-enabled market platform 132, SM-enabled analyzer 134, and/or SM-enabled trader 136. These methods include various techniques illustrated in FIGS. 3-5, each of which is shown as a set of operations that may be performed by one or more entities.

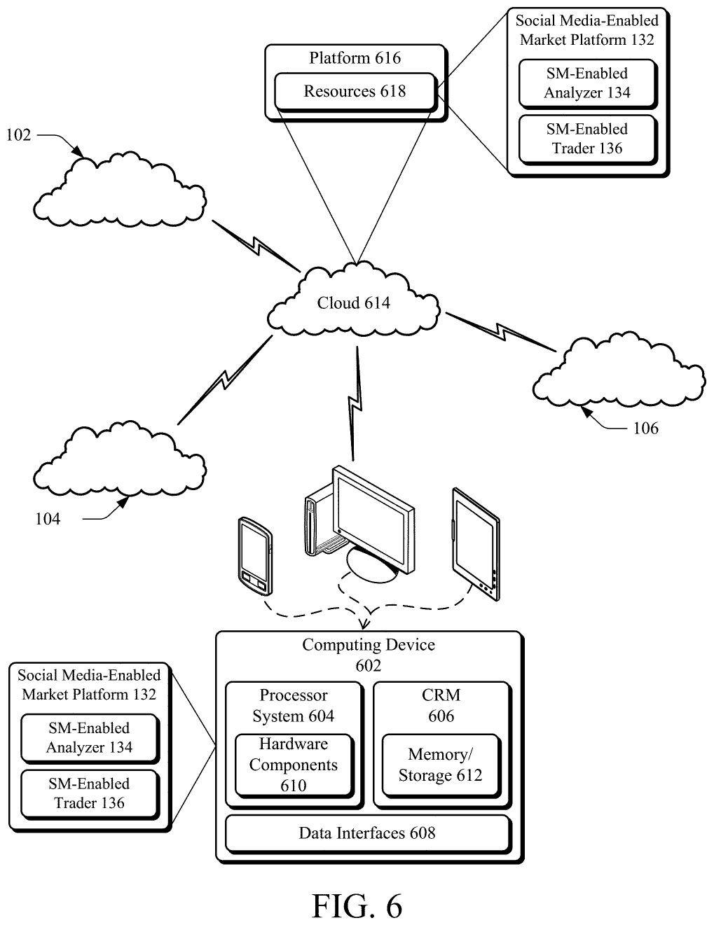

The methods 300 through 500 are not necessarily limited to the orders of operations shown in the corresponding figures. Rather, any of the operations or actions may be repeated, skipped, substituted, or re-ordered to implement various aspects of SM-enabled analysis and trading described herein. Further, these methods may be used in conjunction with one another, in whole or in part, whether performed by the same entity, separate entities, or any combination thereof. In portions of the following discussion, reference will be made to the operating environment 100 of FIG. 1 and various entities or configurations of FIGS. 2 and 6 by way of example. Such reference is not to be taken as limiting described aspects to the operating environment 100, entities, or configurations, but rather as illustrative of one of a variety of examples. Alternately or additionally, operations of the methods may also be implemented by or with entities described with reference to the computing device 602 and/or platform 616 of FIG. 6.

FIG. 3 illustrates an example method 300 for SM-enabled market analysis and trading in accordance with one or more aspects, including operations performed by the SM-enabled platform 132, SM-enabled analyzer 134, and/or SM-enabled trader 136.

At 302, an SM-enabled platform receives TU related information from a social media source or extracts the TU related information from a social media source. The TU related information may include social media content or social media impressions associated with the TU. For example, the SM-enabled platform may obtain or extract social media posts, interactions (e.g., frequency over time), or impressions related to a name or symbol of the TU.

Optionally at 304, the SM-enabled platform receives other TU related information or extracts other TU related from a trading platform. For example, the SM-enabled platform may access a user's account on the trading platform to obtain pricing, volume, available contracts or options, short/long interest, float percentage, or other information, which may be delayed or real time information regarding the TU. Alternatively or additionally the SM-enable platform obtains TU related data from other data sources, such as news sites, information released by the TU organization (e.g., company press release or product update), a user's email, a user's messages, or the like.

At 306, the SM-enabled platform analyzes the TU related information from at least the social media source to generate or provide actionable social media-based (SM-based) trading information or command(s). Alternatively or additionally, the TU related information from at least the social media source is analyzed to generate SM-based information suitable for dissemination to social media platforms or other instances or users of SM-enabled platforms. In some aspects, the TU related information includes one or more of interest, sentiment, or excitement related to a TU, which may reflect or indicate an estimated price for a future point or window in time. For example, the SM-enabled analyzer may generate a variety of useful outputs or actionable information based on the obtained data relating to a TU. Alternately or additionally, the SM-enabled analyzer can generate SM-based TU related information, which may be viewed by a user, disseminated to other users of the SM-enabled platform, or disseminated to other users of social media or trading platforms.

At 308, the SM-enabled platform generates a TU trade order or alters parameters of an existing TU trade order (e.g., buy/sell order, option, future contract, etc.) based on the SM-based trading information.

At 310, the SM-enabled platform provides the TU trade order or altered parameters of the existing TU trade order to a trading platform for execution or implementation.

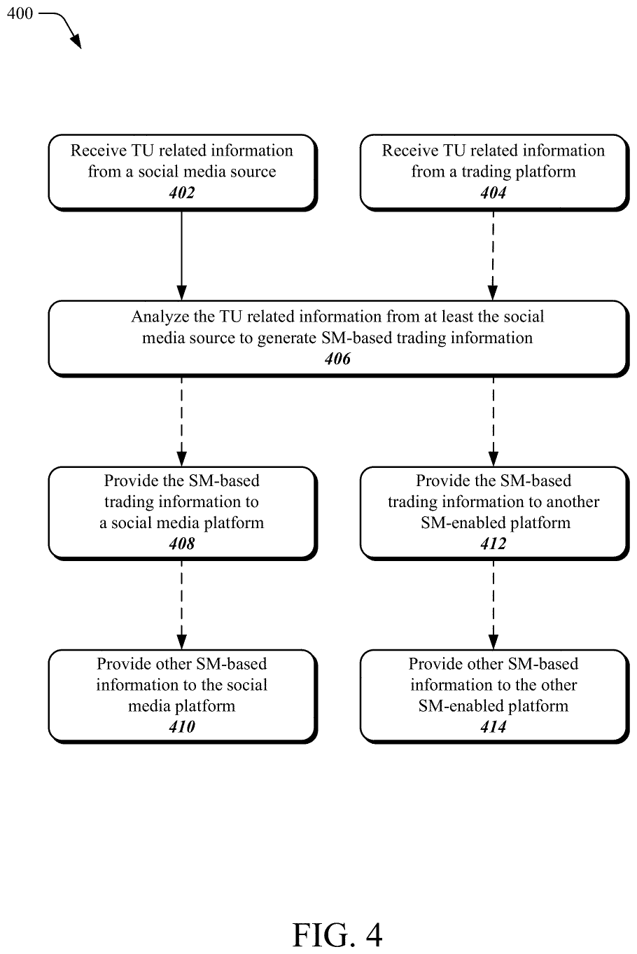

FIG. 4 illustrates an example method 400 for providing SM-based trading information to a social media platform or another SM-enabled platform in accordance with one or more aspects, including operations performed by the SM-enabled platform 132, SM-enabled analyzer 134, and/or SM-enabled trader 136.

At 402, an SM-enabled platform receives TU related information from a social media source or extracts the TU related information from a social media source. The TU related information may include social media content or social media impressions associated with the TU. In some cases, the SM-enabled platform may access a user's account on the social media platform to obtain or receive the TU related information.

Optionally at 404, the SM-enabled platform receives TU related information or extracts other TU related from a trading platform. For example, the SM-enabled platform may access a user's account on the trading platform to obtain pricing, volume, available contracts or options, short/long interest, float percentage, or other information, which may be delayed or real time information regarding the TU. Alternatively or additionally the SM-enable platform obtains TU related data from other data sources, such as news sites, information released by the TU organization (e.g., company press release or product update), a user's email, a user's messages, or the like.

At 406, the SM-enabled platform analyzes the TU related information from at least the social media source to generate or provide actionable social media-based (SM-based) trading information or command(s). Alternatively or additionally, the TU related information from at least the social media source is analyzed to generate SM-based information suitable for dissemination to social media platforms or other instances or users of SM-enabled platforms. In some aspects, the TU related information includes one or more of interest, sentiment, or excitement related to a TU, which may reflect or indicate an estimated price for a future point or window in time.

Optionally at 408, the SM-enabled platform provides the SM-based trading information or command(s) to a social media platform. For example, the SM-enabled platform may disseminate the SM-based trading information to the social media platform, such as to private channels, subforums, or threads. In some cases, this may alert social media users of the SM-based trading information, which may indicate a predicted trend in TU pricing or order flow. Alternatively, the SM-enabled platform may disseminate the SM-based trading information to a public interface of the social media platform.

From operation 408, the method 400 may proceed to operation 410, at which the SM-enabled platform provides other SM-based TU information to the social media platform. Whereas the SM-based trading information may include plaintext or raw TU information, the other SM-based information may include rich formatting or triggers for other user viewing or interactions. For example, the SM-enabled trading platform may generate social media post, thread, reply (e.g., text or emojis), alerts, interact with social media content (e.g., provide a like, a dislike, an upvote, a downvote, broadcast of content, relay of content, or the like).

Optionally at 412, the SM-enabled platform provides the SM-based trading information or command(s) to another SM-enabled platform, SM-enabled platform network, or another SM-enabled platform user. For example, the SM-enabled platform may provide the SM-based trading information or command to the other SM-enabled platform (e.g., an instance of the platform associated with another user) to enable that SM-enabled platform to further analyze or act on the transmitted SM-based trading information. Thus, one SM-enabled platform may send SM-based trading information that causes another SM-enabled platform to generate or modify parameters of an order for TU acquisition or disposition.

From operation 412, the method 400 may proceed to operation 414, at which that SM-enabled platform provides other SM-based information to the other instances or users of the SM-enabled market platform. For example, the SM-enabled trading platform may generate SM-enabled platform content that includes a post, thread, reply (e.g., text or emojis), alerts, interact with platform content (e.g., provide a like, a dislike, an upvote, a downvote, broadcast of content, relay of content, or the like) within the SM-enabled trading platform.

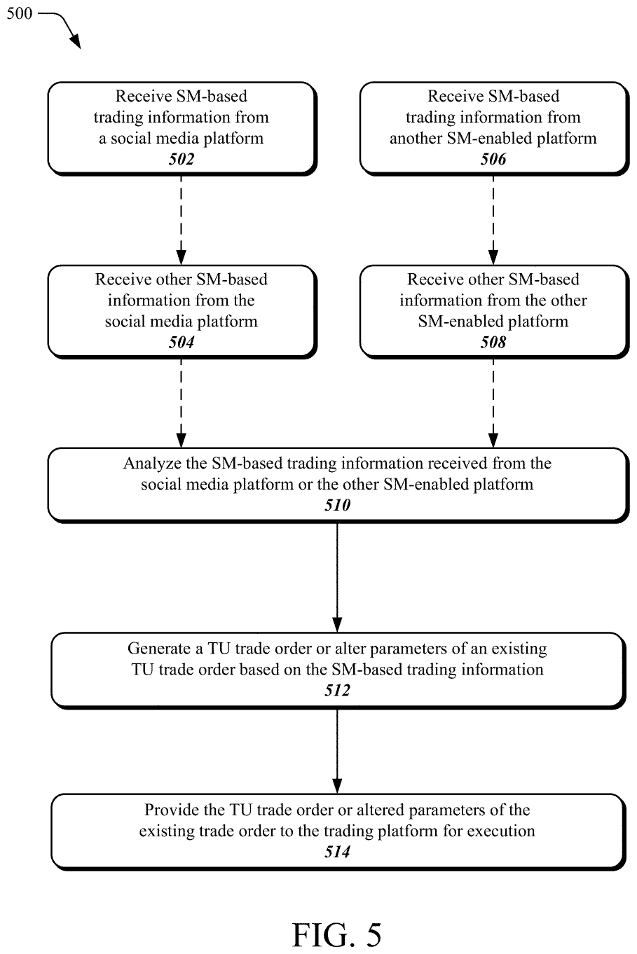

FIG. 5 illustrates an example method 500 for generating or altering parameters of a TU trade order based on information received from another SM-enabled platform in accordance with one or more aspects, including operations performed by the SM-enabled platform 132, SM-enabled analyzer 134, and/or SM-enabled trader 136.

At 502, an SM-enabled platform receives SM-based trading information or command(s) from a social media platform. For example, the SM-enabled platform may receive the SM-based trading information from the social media platform, such as to private channels, subforums, or threads. In some cases, this information is received as an alert of the SM-based trading information, which may indicate a predicted trend in TU pricing or order flow. Alternatively, the SM-enabled platform may receive or obtain the SM-based trading information from a public interface of the social media platform.

From operation 502, the method 500 may proceed to operation 504, at which the SM-enabled platform receives other SM-based TU information from the social media platform. Whereas the SM-based trading information may include plaintext or raw TU information, the other SM-based information may include rich formatting or triggers for other user viewing or interactions. For example, the SM-enabled trading platform may obtain or interact with a social media post, thread, reply (e.g., text or emojis), alerts, record social media content for analysis (e.g., provide a like, a dislike, an upvote, a downvote, broadcast of content, relay of content, or the like).

Optionally at 506, the SM-enabled platform receives SM-based trading information or command(s) from another SM-enabled platform, SM-enabled platform network, or another SM-enabled platform user. For example, the SM-enabled platform may receive the SM-based trading information or command from the other SM-enabled platform (e.g., an instance of the platform associated with another user), enabling the SM-enabled platform to further analyze or act on the received SM-based trading information. Thus, the SM-enabled platform may receive, from another SM-based platform, SM-based trading information that enables or causes the SM-enabled platform to generate or modify parameters of an order for TU acquisition or disposition.

From operation 506, the method 500 may proceed to operation 508, at which the SM-enabled platform receives other SM-based TU information from the other SM-enabled platform. For example, the SM-enabled trading platform may receive SM-enabled platform content that includes a post, thread, reply (e.g., text or emojis), alert, interact with platform content (e.g., observe/count a like, a dislike, an upvote, a downvote, broadcast of content, relay of content, or the like) within the SM-enabled trading platform.

At 510, the SM-enabled platform analyzes the SM-based trading information received from the social media source or the other SM-enabled platform. Thus, the SM-enabled platform receives SM-based trading information that is distributed by the social network and/or other SM-enabled platforms. In aspects, this SM-based trading information includes one or more of interest, sentiment, or excitement related to a TU, which may reflect or indicate an estimated price for a future point or window in time. In other words, the SM-enabled platform receives SM-based trading information that is actionable and does not need to be analyzed. Alternatively or additionally, the SM-enabled platform may analyze SM-based trading information received from at least two of the social media platforms and the other SM-enabled platform to provide aggregate SM-based trading information that is based on or considers previously-processed SM-based trading information provided by at least two separate sources.

At 512, the SM-enabled platform generates a TU trade order or alters parameters of an existing TU trade order (e.g., buy/sell order, option, future contract, etc.) based on the SM-based trading information. For example, the SM-enabled platform may generate a sell order if the price of the TU is expected to decline or generate a buy order if the price of the TU is expected to increase. At 514, the SM-enabled platform provides the TU trade order or altered parameters of the existing TU trade order to a trading platform for execution or implementation.

Example System and Devices

FIG. 6 illustrates an example system at 600 that includes another example computing device 602, which may that is represent of one or more computing systems and/or devices that may implement the various aspects described herein. This is illustrated through inclusion of the SM-enabled platform 132, SM-enabled analyzer 134, and SM-enabled trader 136 in either or both of the computing device 602 and the resources 618 of the cloud 614. The computing device 602 may be, for example, a server of an SM-enabled service provider, a device associated with a client (e.g., a client device) or user, a system-on-chip (SoC), a thin client, and/or any other suitable computing device or computing system (centralized or distributed).

The example computing device 602 as illustrated includes a processor system 604, computer-readable media 606 (CRM 606), and one or more data interfaces 608 that are communicatively coupled, one to another. The data interfaces 608 may enable the computing device 602 and its components to communicate with other devices, networks, instances of SM-enabled platforms, or a user (e.g., I/O ports or peripherals). Although not shown, the computing device 602 may further include a system bus, interconnect fabric, or other data and command transfer system(s) that couple the various components, one to another. The processor system 604 is representative of functionality to perform one or more operations implemented at least partially in hardware. As such, the processor system 604 is illustrated as including hardware components 610 that may be configured as processors, circuitry, functional blocks, IP blocks, and so forth. This may include implementation in hardware as an ASIC, PLC, FPGA, or other logic device formed using one or more semiconductors and/or circuits. The hardware components 610 are not limited by the materials from which they are formed or the processing mechanisms employed therein. For example, processors may comprise various semiconductor(s) and/or transistors (e.g., electronic integrated circuits (ICs)). In such a context, computer-executable instructions may be processor-executable instructions or any other form of executable instructions and associated data for implementing the aspects described herein.

The computer-readable storage media 606 (CRM 606) is illustrated as including memory and/or storage devices 612 (memory/storage 612). The memory/storage 612 represents hardware-based memory or storage associated with one or more computer-readable media. The memory/storage components 612 may include volatile media (e.g., RAM, SRAM, DRAM, etc.) and/or nonvolatile media (e.g., ROM, Flash memory, optical media, magnetic media, etc.). The memory/storage components 612 may include fixed media (e.g., RAM, ROM, a fixed hard drive, etc.) as well as removable media (e.g., Flash memory, a removable hard drive, an optical disc, etc.). The CRM 606 may be configured in a variety of other ways as described herein. The data interfaces 608 are representative of functionality to enable the computing device 602 to communicate with other devices, networks, or users. For example, the data interfaces 606 may include I/O interfaces that enable the computing device 602 to receive commands or information from a user or allow the computing device 602 to present information to the user and/or other components or devices using various I/O devices. Examples of input devices include a keyboard, a cursor control device (e.g., a mouse), a microphone, a scanner, touch functionality (e.g., capacitive, resistive, or other sensors that are configured to detect physical touch or proximity), a camera or image sensor, which may employ visible or non-visible wavelengths such as infrared frequencies to recognize movement as gestures that do not involve touch, and so forth. Examples of output devices include a display device (e.g., a monitor, screen, or projector), speakers, a printer, a NIC, tactile-response device, haptic feedback, and so forth. Thus, the computing device 602 may be configured in a variety of ways as further described herein to support user interaction.

Various techniques may be described herein in the general context of software, hardware components, applications, services, or program modules. Generally, such modules include instructions, code, routines, programs, objects, elements, components, data structures, and so forth that perform particular actions or implement particular abstract data types. The terms “module,” “functionality,” and “component” as used herein generally represent software, firmware, hardware, or a combination thereof. The features of the techniques described herein are platform-independent, meaning that the techniques may be implemented on a variety of computing platforms having a variety of processors, which may be formed as a centralized or distributed computing platform.

An implementation of the described modules and techniques may be stored on or transmitted across some form of computer-readable media. The computer-readable media may include a variety of media that may be accessed by the computing device 602. By way of example, and not limitation, computer-readable media may include “computer-readable storage media” and “computer-readable signal media.” As described herein “computer-readable storage media” (e.g., CRM 606) may refer to media and/or devices that enable persistent and/or non-transitory storage of information in contrast to mere signal transmission, carrier waves, or signals per se. Thus, in the context of the present disclosure, the computer-readable storage media refers to non-signal bearing media. The computer-readable storage media includes hardware-based memory or storage devices that are suitable for storage of information such as computer-readable instructions, processor-executable instructions, data structures, program modules, logic elements/circuits, or other data, examples of which are provided throughout the disclosure.

Alternatively, “computer-readable signal media” may refer to a signal-bearing medium that is configured to transmit instructions or data to the hardware of the computing device 602, such as via a network. Signal media typically may embody computer-readable instructions, data structures, program modules, or other data in a modulated data signal, such as carrier waves, data signals, or other transport mechanism. Signal media also include any information delivery media. The term “modulated data signal” means a signal that has one or more of its characteristics set or changed in such a manner as to encode information in the signal. For example, various signal-based communication media include wired media such as a wired network or direct-wired connection, and wireless media such as acoustic, RF, infrared, and other wireless media.

As described herein, the hardware components 610 and CRM 606 may represent modules, programmable device logic and/or fixed device logic implemented in a hardware-based form that may be implemented in some aspects to perform or cause various operations of the techniques described herein, such as to perform one or more instructions. The hardware may include components of an integrated circuit or system-on-chip, an ASIC, an FPGA, CPLD, and other implementations in silicon or other hardware. In this context, the hardware may operate as a processing device that performs program tasks defined by instructions and/or logic embodied by the hardware as well as a hardware-based memory or storage that stores instructions or code for execution, e.g., the computer-readable storage media described herein.

Combinations of the described aspects or features may also be employed to implement various techniques described herein. Accordingly, software, hardware, or executable modules may be implemented as one or more instructions, code, data, and/or logic embodied on some form of computer-readable storage media and/or by one or more hardware components 610. The computing device 602 may be configured to implement various instructions and/or functions corresponding to the software and/or hardware modules. Accordingly, implementation of a module or functional block that is executable by a processor or controller of the computing device 602 as software or firmware may be achieved at least partially in hardware, e.g., through use of computer-readable storage media and/or hardware components 610 of the processor system 604. The instructions and/or functions may be executable/operable by one or more apparatuses or articles of manufacture (e.g., one or more computing devices 602, a distributed computing device 602, a peer network of computing devices 602, and/or respective processor systems 604) to implement the techniques, modules, functions, and examples described herein.

The aspects described herein may be supported by various configurations of the computing device 602 and are not limited to the specific examples of the aspects described herein. These features or functionalities may also be implemented all or in part through use of a distributed system, such as over a “cloud” 614 via a platform 616 that supports processing and/or other functionalities as described with reference to the computing device 602. In aspects, the cloud 614 includes and/or represents a platform 616 for resources 618, which may include compute, storage, networking, or other resources. The platform 616 abstracts underlying functionality of hardware (e.g., servers, compute resources, memory resources, storage resources, etc.) and software resources of the cloud 614 or cloud service implemented on through the resources 618. The resources 618 may include applications, services, and/or data that can be accessed or used while computer processing is executed on servers that are remote from the computing device 602. The resources 618 can also include services provided over the Internet and/or through a subscriber network, a social media network, a brokerage service, a trading platform, or other various networks that enable communication between the computing device 602 and the cloud 614 (e.g., cellular, WLAN, WPAN, or peer networks).

The platform 616 may represent abstracted resources and functions to connect the computing device 602 with other computing devices or users/members of a service, website, social media platform, brokerage platform, trading platform, SM-enabled platform, any combination thereof, or the like. The platform 616 may also serve to abstract scaling of resources to provide a corresponding level of scale to encountered demand for the resources 618 that are implemented via the platform 616. As such, in an interconnected or distributed device embodiment, implementation of functionality described herein may be distributed throughout the system 600 and entities thereof. For example, an aspect or functionality described herein may be implemented in part on the computing device 602 as well as via the platform 616 that represents an abstraction of the functionality to the cloud 614.

In some aspects, the platform 616 can provide a cloud-based service for implementing the techniques descried herein, such as analyzing social media content to provide social media-based trading information or commands or social media-based TU information. In aspects, the platform 616 is capable of communicating with various social networks 102, trading platforms 104, and/or other data sources 106 receive social media content or other TU related information. The platform 616 may also communicate with a remote server (not shown) receive non-public trading account or user information (e.g., private networks). By implementing one or more of the techniques, the SM-enabled market platform can provide social media-based information or commands that a user may use for a variety of purposes, which may include generating TU trade order, altering parameters of existing TU orders, disseminating TU related information to social media platforms, coordinating TU orders/order parameters with other users or instances of SM-enabled market platforms, and so forth.

In the following some example implementations of an SM-enabled platform are described:

In some cases, a user downloads an SM-enabled platform app and sets up an account with a username/login, which may be same or different from the user's credentials for a social media platform, trading platform, or other platform. If not public, the user may also enter credentials for one or more of his/her associated social media platform, trading platform, or other platform—allowing the SM-enabled platform to connect, associate with, access information from, and provide information to those respective platforms.

In other words, the SM-enabled platform can use the user provided credentials to associate with and link into the user's social media platform, trading platform, or other platforms.

The SM-enabled platform may obtain social media content or gauge social media interest associated with one or more TUs (e.g., stock symbols or commodities). For example, the SM-enabled platform may analyze social media content to measure or determine a number of times a TU is mentioned, a context in which a TU is mentioned or names, and/or a level of interest in a TU—based a number of a social media post about a specific TU is replied to, a number of views, a social media vote, thread length, number or replies/comments, or like score, and so on.

Using the SM-based interest or sentiment associated with the TU, the SM-enabled platform can generate actional SM-based trading information for commands. These SM-based trading information for commands may be provided by the SM-enabled platform to the user's trading platform to cause the trading platform to execute trade orders or modify parameters of trade orders for the TU (e.g., without user interaction, confirmation, approval, etc.). For example, the SM-enabled platform may cause the trading platform to liquidate a short or long position based on a price movement predicted based on social media interest. Alternatively, the SM-enabled platform may cause the trading platform to generate (e.g., buy, obtain, form, order) a short or long position for the user based on a price movement predicted based on social media interest or sentiment. In other cases, the SM-enabled platform may cause the trading platform to hedge a current position held by a user to protect the user from adverse effects of an expected price movement of the TU in the market (short term or long term). In other words, the SM-enabled platform may buy or sell stocks (or cause the trading platform to do so) based on social media interest associated with a TU (e.g., a number of upvotes, mentions, emojis, likes, associated with a TU symbol). In aspects the SM-enabled platform may decode emojis into normal language or a sentiment score to enable the SM-enabled platform to determine interest, activity level, or sentiment in a TU or stock symbol. Based on social media interest in a TU, the SM-enabled platform may generate or change parameters of a trade order for the TU.

What is claimed is:

1. A method comprising:
receiving, from a social media source, information related to a tradable commodity;
analyzing the information related to the tradable commodity to generate social media-based trading information that reflects a price change in the commodity based on the information received from the social media source; and
generating a trade order for the tradable commodity based on the social media-based trading information.

2. The method of claim 1, wherein:
the method is implemented by a social media-enabled market platform, and the method further comprises:
transmitting, by the social media-enabled market platform, the trade order generated based on the social media trading information to a commodity trading platform to cause the commodity trading platform to execute the trade order for the tradable commodity.

3. The method of claim 1, wherein the social media-based trading information comprises one of:
an indication or measurement of social media interest in the tradable commodity based on the information received from the social media source;
an indication or measurement of social media sentiment in the tradable commodity based on the information received from the social media source; or
an indication or measurement of a prediction for a price or a trading volume of the tradable commodity based on the information received from the social media source.

4. The method of claim 1, wherein the information related to the tradable commodity comprises one of:
a number of posts or threads related to the tradable commodity;
a number of replies related to the tradable commodity;
a number of votes related to the tradable commodity;
an indication of popularity associated with the tradable commodity; or
a frequency or number of interactions with social media content associated with the tradable commodity.

5. The method of claim 1, wherein the information related to the tradable commodity does not comprise textual or numeric content, and the method further comprises:
decoding non-textual and non-numeric content into textual content or numerical content; and
analyzing the decoded textual content or the decoded numerical content to determine the social media-based trading information for the tradeable commodity.

6. The method of claim 5, wherein the non-textual and non-numeric content comprises emojis, emoticons, voting indicators, or images associated with social media content related to the tradable commodity.

7. The method of claim 2, further comprising:
receiving, by the social media-enabled market platform and from a user, credentials for a social media account of the user for the social media source;
providing, by the social media-enabled market platform, the credentials to the social media source to enable access to social media content of the social media source; and
receiving, by the social media-enabled market platform and from the social media source, the information related to a tradable commodity while accessing the social media source using the credentials of the user.

8. The method of claim 2, further comprising:
receiving, by the social media-enabled market platform and from a user, credentials for a commodity trading account of the user for the commodity trading platform;
providing, by the social media-enabled market platform, the credentials to the commodity trading platform to enable access to the commodity trading platform by the social media-enabled market platform; and
transmitting, by the social media-enabled market platform and to the commodity trading platform, the trade order for the tradable commodity while accessing the social media source using the credentials of the user.

9. The method of claim 1, wherein the social media-based trading information is first social media-based trading information and the method further comprises:
receiving, from a social media-enabled trading platform, second social media-based trading information related to the tradable commodity; and
generating the trade order for the tradable commodity based on the first social media-based trading information and the second social media-based trading information received from the social media-enabled trading platform.

10. The method of claim 1, further comprising:
presenting, to a user, the trade order for the tradable commodity that is generated based on the social media-based trading information;
receiving, from the user, confirmation to execute the trade order for the tradable commodity; and
transmitting, in response to receiving the confirmation from the user, the trade order generated based on the social media trading information to a commodity trading platform to cause the commodity trading platform to execute the trade order for the tradable commodity.

11. The method of claim 1, wherein:
the method is implemented by a social media-enabled market platform, and the method further comprises:
transmitting, by the social media-enabled market platform and without user interaction, the trade order generated based on the social media trading information to a commodity trading platform to cause the commodity trading platform to execute the trade order for the tradable commodity.

12. The method of claim 1, wherein transmitting the trade order generated based on the social media trading information to the commodity trading platform is effective to cause the commodity trading platform to generate or alter a portfolio position on the tradable commodity for the user based on price movement predicted based on the information received from the social media source.

13. An apparatus comprising:
a processor;
network interface configured to communicate data over a network; and
a hardware-based memory storing instructions that, responsive to execution by the processor, implement a social media-enabled market platform configured to:
receive, via the network interface and from a social media source, information related to a tradable commodity;
analyze the information related to the tradable commodity to generate social media-based trading information that reflects a price change in the commodity based on the information received from the social media source; and
generate a trade order for the tradable commodity based on the social media-based trading information.

14. The apparatus of claim 13, wherein the social media-enabled market platform is further configured to:
transmit the trade order generated based on the social media trading information to a commodity trading platform to cause the commodity trading platform to execute the trade order for the tradable commodity.

15. The apparatus of claim 13, wherein the social media-based trading information comprises one of:
an indication or measurement of social media interest in the tradable commodity based on the information received from the social media source;
an indication or measurement of social media sentiment in the tradable commodity based on the information received from the social media source; or
an indication or measurement of a prediction for a price or a trading volume of the tradable commodity based on the information received from the social media source.

16. The apparatus of claim 13, wherein the information related to the tradable commodity comprises one of:
a number of posts or threads related to the tradable commodity;
a number of replies related to the tradable commodity;
a number of votes related to the tradable commodity;
an indication of popularity associated with the tradable commodity; or
a frequency or number of interactions with social media content associated with the tradable commodity.

17. The apparatus of claim 13, wherein the information related to the tradable commodity does not comprise textual or numeric content, and the social media-enabled market platform is further configured to:
decode non-textual and non-numeric content into textual content or numerical content; and
analyze the decoded textual content or the decoded numerical content to determine the social media-based trading information for the tradeable commodity.

18. The apparatus of claim 17, wherein the non-textual and non-numeric content comprises emojis, emoticons, voting indicators, or images associated with social media content related to the tradable commodity.

19. The apparatus of claim 13, wherein the social media-enabled market platform is further configured to:
receive, from a user, credentials for a social media account of the user for the social media source;
provide, the credentials to the social media source to enable access to social media content of the social media source; and
receive, from the social media source, the information related to a tradable commodity while accessing the social media source using the credentials of the user.

20. The apparatus of claim 13, wherein the social media-enabled market platform is further configured to:
receive, from a user, credentials for a commodity trading account of the user for the commodity trading platform;
provide the credentials to the commodity trading platform to enable access to the commodity trading platform by the social media-enabled market platform; and
transmit, to the commodity trading platform, the trade order for the tradable commodity while accessing the social media source using the credentials of the user.
